(19) United States
(12) Patent Application Publication
(10) Pub. No.: US 2017/0041042 A1
(43) Pub. Date: Feb. 9, 2017

(54) METHOD OF WIRELESS COMMUNICATION IN UNLICENSED SPECTRUM AND RELATED APPARATUS USING THE SAME

(71) Applicant: Acer Incorporated, New Taipei City (TW)

(72) Inventor: Hung-Yu Wei, New Taipei City (TW)

(21) Appl. No.: 15/078,855

(22) Filed: Mar. 23, 2016

Related U.S. Application Data
(60) Provisional application No. 62/200,131, filed on Aug. 3, 2015.

(51) Int. Cl. H04B 1/715; H04W 16/14; H04W 16/32; H04W 72/04; H04W 72/08

(52) U.S. Cl. CPC H04B 1/715; H04W 72/0453; H04W 72/0446; H04W 72/082; H04W 72/042; H04W 16/32; H04W 16/14

(57) ABSTRACT

The disclosure is directed to a method of wireless communication in an unlicensed spectrum and related apparatus using the same. In one of the exemplary embodiments, the disclosure is directed to a method of wireless communication in an unlicensed spectrum, applicable to a base station, the method would include not limited to: establishing a primary serving cell (Pcell) in a licensed spectrum; establishing a secondary serving cell (Scell) in the unlicensed spectrum to operate as a virtual frequency cell (VFC); configuring a frequency hopping sequence of the VFC; transmitting the frequency hopping sequence to the Scell through the Pcell; and controlling the Scell to operate according to the frequency hopping sequence.

### CROSS REFERENCE TO RELATED APPLICATION

This application claims the priority benefit of U.S. provisional application Ser. No. 62/200,131, filed on Aug. 3, 2015. The entirety of the above-mentioned patent application is hereby incorporated by reference herein and made a part of specification.

### TECHNICAL FIELD

The present disclosure is directed to a method of wireless communication in an unlicensed spectrum and related apparatus using the same.

### BACKGROUND

Conventionally, cellular systems operate in a proprietary or licensed frequency spectrum in which base stations and wireless terminals communicate through a radio frequency (RF) spectrum licensed to a wireless operator. Cellular network communication systems have been expanding usages to unlicensed spectrums such as the industrial, scientific, and medical (ISM) radio bands or other free spectrums. Using unlicensed spectrums for Long Term Evolution (LTE) communication systems has drawn attentions from telecommunication equipment vendors and operators. One of the reasons for such attentions is the limited sources of licensed spectrums. In order to provide high throughput services to many users, a LTE system might use unlicensed spectrum for communications.

Currently, LTE Licensed-Assisted Access (LTE-LAA) is under discussion for 3GPP Release 13 and future releases. The framework for Licensed-Assisted Access unlicensed spectrum is also known as Unlicensed LTE (LTE-U). Unlicensed LTE will likely be a key feature for a next generation cellular system. As LAA wireless communications is conducted in unlicensed or free spectrums, there could be other communications devices, using both the same or different radio access technologies (RATs), would like to communicate in the same frequency spectrum. For example, unlicensed LTE operations will need to co-exist with existing Wi-Fi radios.

Thus, one of the major challenges would be to operate LAA in an unlicensed frequency bands so as to co-exist with other radio access technologies that also use the unlicensed bands. Since the unlicensed band is shared by other radio access technologies such as Wi-Fi, and there are some multi-mode radio equipment and radio devices such a base station or a smartphone that supports both IEEE 802.11ac and LAA, those RATs using unlicensed spectrum might have different configurations for channelization. Co-existence and interworking among multiple RATs with different channelization (e.g. some radios are narrow band, some radios are wide band, some radios might possibly operate with variable bandwidth) will be an issue to be resolved.

FIG. 1 illustrates channelization of a 5 GHz frequency band taken from 3GPP TR 36.889 V0.4.0 (2015-04) according to the IEEE 802.11 standard. It is evident from FIG. 1 that different unlicensed communication systems currently have different channelization schemes. To order for a wireless communication system to achieve reasonable efficiency, the wireless operation might need to consider how to configure communication devices within a multi-channel environment in which interferences could occur from various unexpected sources. Adaptive selection among several unlicensed channels for wireless communications might reduce interference, increase communication efficiency, and improve the system performance. Therefore, an efficient mechanism for configuring an unlicensed band in a multi-channel environment would need to be proposed for future wireless communications.

### SUMMARY OF THE DISCLOSURE

Accordingly, the present disclosure is directed to a method of wireless communication in an unlicensed spectrum and related apparatus using the same.

In one of the exemplary embodiments, the present disclosure is directed to a method of wireless communication in an unlicensed spectrum, applicable to a base station, the method would include not limited to: establishing a primary serving cell (Pcell) in a licensed spectrum; establishing a secondary serving cell (Scell) in the unlicensed spectrum to operate as a virtual frequency cell (VFC); configuring a frequency hopping sequence of the VFC; transmitting the frequency hopping sequence to the Scell through the Pcell; and controlling the Scell to operate according to the frequency hopping sequence.

In one of the exemplary embodiment, the present disclosure is directed to a method of wireless communication in an unlicensed spectrum, applicable to a user equipment, the method would include not limited to: attaching to a primary serving cell (Pcell) in a licensed spectrum; attaching to a secondary serving cell (Scell) in the unlicensed spectrum; receiving a control signalling message through the primary serving cell (Pcell) to operate in a virtual frequency cell (VFC) of the Scell; receiving a frequency hopping sequence of the VFC from the control signalling message; and operating in the VFC according to the frequency hopping sequence.

In one of the exemplary embodiment, the present disclosure is directed to a user equipment which includes not limited to a wireless transceiver and a processor coupled to the wireless transceiver. The processor is configured at least for: establishing a primary serving cell (Pcell) in a licensed spectrum; establishing a secondary serving cell (Scell) in the unlicensed spectrum to operate as a virtual frequency cell (VFC); configuring a frequency hopping sequence of the VFC; transmitting the frequency hopping sequence to the Scell through the Pcell; and controlling the Scell to operate according to the frequency hopping sequence.

In order to make the aforementioned features and advantages of the present disclosure comprehensible, exemplary embodiments accompanied with figures are described in detail below. It is to be understood that both the foregoing general description and the following detailed description are exemplary, and are intended to provide further explanation of the disclosure as claimed.

It should be understood, however, that this summary may not contain all of the aspect and embodiments of the present disclosure and is therefore not meant to be limiting or restrictive in any manner. Also the present disclosure would include improvements and modifications which are obvious to one skilled in the art.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 illustrates channelization of a 5 GHz frequency band according to the IEEE 802.11 standard.

FIG. 2A illustrates a mapping relationship between a virtual cell ID and an actual cell ID in accordance with one of the exemplary embodiments of the disclosure.

FIG. 2B illustrates changing a relationship between a virtual cell ID and an actual cell ID in accordance with one of the exemplary embodiments of the disclosure.

FIG. 3 illustrates an operation of a virtual frequency cell in a wireless communication network in accordance with one of the exemplary embodiments of the disclosure.

FIG. 4 illustrates a channel hopping operation in accordance with one of the exemplary embodiments of the disclosure.

FIG. 5 illustrates a method of wireless communication in an unlicensed spectrum, applicable to a base station in accordance with one of the exemplary embodiments of the disclosure.

FIG. 6 illustrates a method of wireless communication in an unlicensed spectrum, applicable to a user equipment in accordance with one of the exemplary embodiments of the disclosure.

FIG. 7 illustrates a basic functional block diagram of a base station in accordance with one of the exemplary embodiments of the disclosure.

FIG. 8 illustrates a basic functional block diagram of a user equipment in accordance with one of the exemplary embodiments of the disclosure.

### DETAILED DESCRIPTION OF DISCLOSED EMBODIMENTS

Reference will now be made in detail to the present exemplary embodiments of the disclosure, examples of which are illustrated in the accompanying drawings. Wherever possible, the same reference numbers are used in the drawings and the description to refer to the same or like parts.

By operating under a multi-channel environment in which wireless communications in a unlicensed spectrum could easily be interfered from various unlicensed operations having different channelization schemes, the disclosure describes a method and related apparatus of a wireless communication system that performs channel aware scheduling and frequency hopping in a virtual cell within an unlicensed spectrum so as to reduce interference, increase communication efficiency, and improve the overall system performance.

The disclosure proposes establishing a mapping relationship between at least one virtual frequency cell (VFC) and at least one actual frequency cell (AFC). A macro cell base station may establish a primary serving cell (Pcell) and one or more secondary serving cells (Scells) under a carrier aggregation operation. The Pcell operates under the primary carrier frequency and is for a UE to perform an initial connection establishment procedure or to initiate a connection re-establishment procedure; the Scell operates under a secondary carrier frequency which could be configured once a radio resource control (RRC) connection is established and could be used to provide additional radio resources. A VFC could be deployed by a base station in a Scell to operate in an unlicensed spectrum.

A VFC could be assigned by a base station to have an identifier (ID) which is termed as a virtual frequency cell ID (VFC-ID) in this disclosure, and an AFC could be assigned by a base station to have a ID which is termed as an actual frequency cell ID (AFC-ID) in this disclosure. The assignment could be in a static or semi-static manner. A single VFC ID could be mapped to one or several AFC ID's.

The mapping relationship may also include a set of wireless channels. For example, one specific wireless channel could be configured as one AFC. Also for example, a single VFC could be configured with a set of wireless channels. Thus, the actual wireless channel in the VFC could be selected from this set of wireless channels.

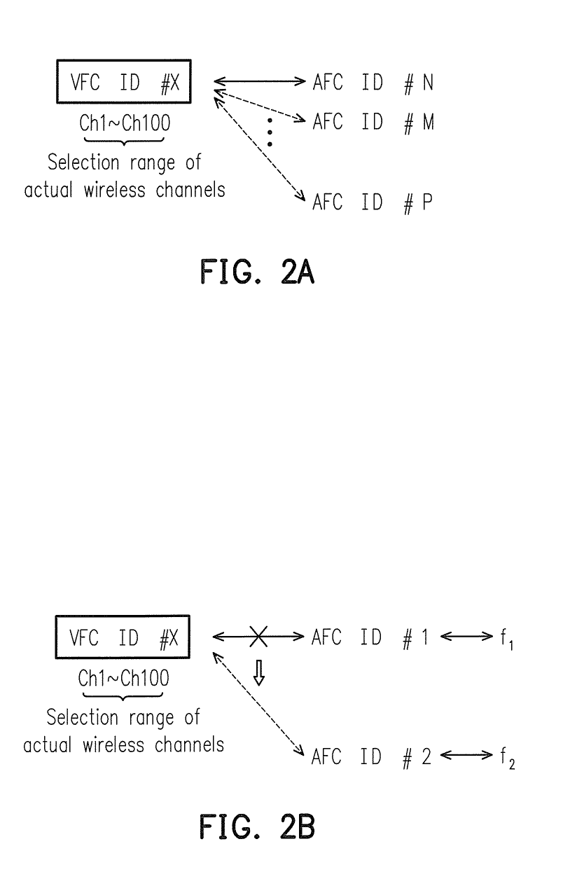

As an example, FIG. 2A illustrates a mapping relationship between a virtual cell ID and an actual cell ID in accordance with one of the exemplary embodiments of the disclosure. In FIG. 2A, a VFC could be assigned with a VFC ID #X, where X is a non-zero integer. Also, the VFC ID #X could be configured with a set of wireless channels which is channel 1˜channel 100 in this example. Each of such channels may correspond with a different AFC. Also in FIG. 2A, the VFC ID #X is configured to potentially associate with AFC ID #N, AFC ID #M, and AFC ID #P, where N, M, and P are different non-zero integers, and each of these IDs may correspond to a different channel selected within channel 1˜channel 100.

One VFC could be configured to change its operating frequency. When a base station has to switch the operating frequency of a Scell, the Scell would the VFC to be mapped to a different AFC. In other words, when there is a change of operation frequency of a Scell in a unlicensed spectrum, the mapping relationship of the VFC and AFCs may change from one VFC-ID to one AFC-ID (e.g. VFC ID #1˜AFC ID #1) to the VFC-ID to a different AFC-ID (e.g. VFC ID #1-AFC ID #2) such that while the AFC ID changes, the VFC stays the same.

As an example, FIG. 2B illustrates changing a relationship between a virtual cell ID and an actual cell ID in accordance with one of the exemplary embodiments of the disclosure. According to FIG. 2B, AFC #1 uses carrier frequency f1 and has a physical cell ID AFC ID #1; AFC #2 uses carrier frequency f2 and has a physical cell ID AFC ID #2. Assuming that a base station currently uses VFC ID #X, wherein X is a nonzero integer, in an unlicensed spectrum, but the base station which currently uses f1 in an unlicensed spectrum may decide to change from f1 to f2 for wireless communications in the unlicensed spectrum. In this way, the base station may prefer to use the same VFC ID. Consequently, the base station in this case would keep the same VFC ID #X. However, for the change of the carrier frequency from f1 to f2, the mapping between VFC ID #X to AFC ID #1 would be modified to VFC ID #X to AFC ID #2 as shown in FIG. 2B.

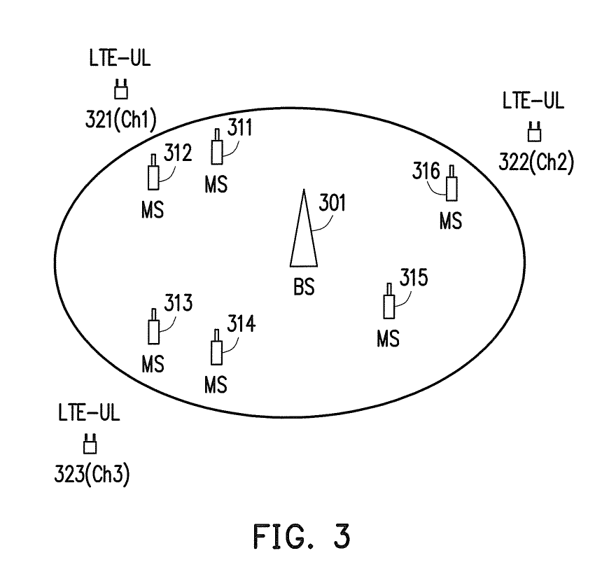

FIG. 3 will be referred to for illustrating an operation of a virtual frequency cell in a wireless communication network in accordance with one of the exemplary embodiments of the disclosure. In the example of FIG. 3, the wireless network has, not limited to, a base station 301, multiple UEs (i.e. mobile stations or MS) 311, 312, 313, 314, 315, 316, a LTE unlicensed radio (LTE-UL) operating in channel 1 321, a LTE unlicensed radio (LTE-UL) operating in channel 2 322, and a LTE unlicensed radio (LTE-UL) operating in channel 3 323.

Each of the UEs would attach to a VFC. Before attaching to a VFC, each of the UEs 311˜316 may attach to the BS 301 through a Pcell of the BS 301 via a licensed carrier frequency. After attaching to the Pcell, any one of the UEs 311˜316 could be configured by BS 301 to initially communicate with the BS 301 in one of the AFCs that are associated with the serving VFC. Any one of the UEs 311˜316 in the active AFC may use the wireless channel in this active AFC to communicate among the BS 301 and other UEs. In order to change the AFC, the UEs may receive a control signaling message with regard to the VFC operation. In response to receiving the control signaling message, any one of the UEs 311˜316 may change its active AFC as instructed by the controlling signaling message while the VFC remains the same.

The same or a different control signaling message may also inform any one of the UEs 311˜316 with regard to the rules or patterns of changing AFCs. For example, after receiving a control signaling message, the UE 311˜316 may automatically change the active AFC while the VFC remains the same. In one of the exemplary embodiments, one VFC might configure all the attached wireless devices (e.g. 311˜316) to follow the same AFC changing pattern. This could be considered as an exemplary embodiment of “frequency-hopping virtual cell” which will be explained in further details.

In general, the VFC and AFC concept could be applied to any unlicensed cellular operations such as 3GPP LAA, unlicensed LTE, or any of the future 5G cellular operations in an unlicensed spectrum. According to one of the exemplary embodiments, the VFC could be first configured to operate in one unlicensed channel, and subsequently all of the UEs that are associated with this virtual cell will communicate wirelessly by using the first unlicensed channel. Subsequently, the virtual cell could be re-configured to operate in a different unlicensed channel, and All the UEs that are associated with this virtual cell would communicate by using this different unlicensed channel. The change of unlicensed channel could be triggered by an eNB or any of a network control entity to change the carrier frequency of a VFC from a first unlicensed channel to a second unlicensed cell.

Next, the frequency hopping virtual cell operation is described in further details. A frequency hopping virtual cell is a VFC which operates under a frequency hopping sequence in a per wireless cell basis. The frequency hopping sequence could be a predetermined hopping sequence assigned by a base station or could be dynamically determined by the base station according to the instantaneous network interference condition. This differs from the conventional wireless device frequency hopping operation which occurs not in a per cell basis but in a per device basis. Conventionally, a wireless cell such as a cell in a LTE system is configured with a static frequency band in which frequency hops do not occur. In this disclosure, as a cell may include at least one base station and several devices, multiple UE may hop together simultaneously from one operating frequency to another.

Thus, as a frequency hopping virtual cell is a VFC that operates in different frequency channels through a hopping sequence, a VFC would then operate in a frequency hopping manner by changing carrier frequencies according to a configured sequence. For example, a VFC configured with a hopping sequence [f1 f3 f2 f4] would operate at carrier frequency f1 in time 1, operate at carrier frequency f3 in time 2, operate at carrier frequency f2 in time 3, and operate at carrier frequency f4 in time 4, where f1, f2, f3, and f3 are carrier frequencies for different channels within an unlicensed spectrum; time 1, time 2, time 3 and time 4 could be evenly spaced or unevenly spaced. According to one of the exemplary embodiments, the carrier frequency may switch back to f1 at time 5 and repeat the same sequence, [f1 f3 f2 f4]. Alternatively, the hopping sequence could be one time only, and thus the carrier frequency would not change until another set of hopping sequence as received from a base station according to another control signaling message.

In general, a UE would obtain a virtual cell frequency hopping sequence (e.g. [f1 f3 f2 f4]) by receiving a control signaling message from a base station; alternatively, the UE could also store such sequence inherently so that a control signaling message would not be required. The virtual cell frequency hopping sequence (e.g. [f1 f3 f2 f4]) could be configured through a control channel that is out of band from the operating frequency of the unlicensed spectrum. For example, in LTE-LAA operation, the control channel would typically operate in the Pcell which uses a licensed channel. The SCell which operates within an unlicensed frequency might operate as a frequency hopping virtual cell as previously described.

In one of the exemplary embodiments, a base station may send a control signaling message through a licensed PCell to configure an unlicensed band VFC, which will served as an unlicensed SCell for data transmission by using the unlicensed band. For example, a LTE eNB may configure such unlicensed SCell as a frequency hopping virtual cell by transmitting control messages over Pcell to a set of UEs that operate in the same frequency-hopping VFC. The control messages would include not limited to a frequency hopping sequence. The control message could be transmitted over a physical downlink control channel (PDCCH) in a PCell by using a specific radio network temporary identifier (RNTI). The RNTI would be an identifier embedded within the PDCCH so that all UEs for which the control signaling message is intended would receive the control signaling message by obtaining the RNTI through blind decodes of the PDCCH. In this way, all UEs which are identifier by the same RNTI may perform the same frequency hopping sequence in the same unlicensed SCell.

Besides the control signaling messages as aforementioned, the base station may transmit another activation signaling to start data transmission on an unlicensed Scell. For example, the base station may transmit an activation signaling out of band from the unlicensed Scell (e.g. through a Pcell by using a licensed spectrum) to activate the frequency hopping operation. Similarly, separate control signaling would also be needed for modifying and deactivating the frequency hopping operation.

The proposed frequency hopping unlicensed cell could have several advantages. One advantage of such frequency hopping unlicensed cell is improved system performance with frequency diversity gain. By performing frequency hopping, the Scell would be able to avoid inferences which could be undetectable or unknowable by the base station in real time by hopping around various frequencies.

One UE in a frequency hopping unlicensed cell could be scheduled for a potential uplink transmission per configured sub-band or per configured symbols or time slots. However, the actual uplink transmission for each LTE-LAA UE would depend on the result of a listen-before-transmission attempt which will be elucidate in further detail.

The disclosure proposes a channel aware scheduling mechanism for a frequency hopping virtual cell. One of the purposes of the proposed channel aware scheduling for frequency hopping VFC would be to alleviate problems associated with the hidden terminals such as hidden Wi-Fi access point (AP) in an unlicensed band. For the channel aware scheduling, a base station would schedule wireless devices for uplink in various time slots which could be determined by the base station be time slot that has the least inferences for these scheduled wireless devices. However, before the actual uplink transmission, each wireless device would perform a passive scan of various channels for potential interferences right before the scheduled time slot. If strong interference is detected in a particular channel, no uplink transmission would occur in that particular channel in which strong interference has been detected. In that case, the wireless device may select a different channel for transmission. The channel aware scheduling for frequency-hopping virtual cell may also be applied for downlink data transmissions.

Referring to FIG. 3 for example, assuming that the base station 301 is configured to operate as a VFC which is assumed to operate in channel (CH) 1 or channel 2 or channel 4 in the unlicensed spectrum. The base station 301 may schedule for uplink or downlink communications to avoid interference from other unlicensed band radios (e.g. LTE-UL 321, 322, 323). Thus, MS 316 which is closed to LTE-UL 322 operating in channel 2 could be scheduled for communications when the VFC operates in channel 1 or channel 4. Similarly, MS 313 or MS 314 might be scheduled for communications when the VFC operates in channel 1 or channel 2. MS 311 or MS 312 might be scheduled for communications when the VFC is operated in channel 2 or channel 4.

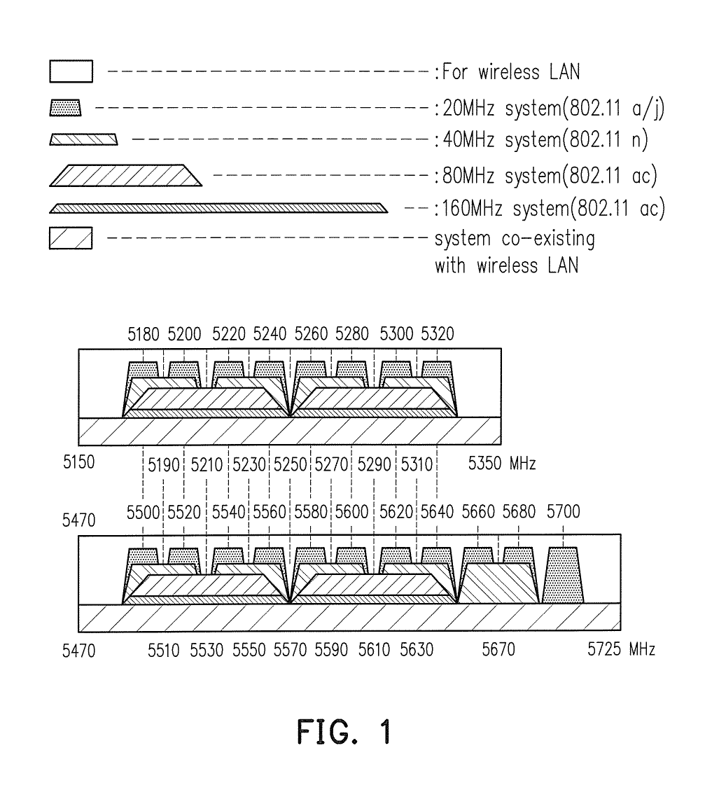

In general, the disclosure proposes that for wireless communications in an unlicensed frequency spectrum, a wireless UE might need to conduct a clear channel assessment or carrier sensing before data transmission by performing a passive scan of multiple channels which may potentially be available before transmission. As shown in FIG. 1, there could be numerous channels used by various communication systems in the unlicensed spectrum. Thus, a wireless UE would need to conduct carrier sensing in multiple unlicensed channels and select one of the available channels to transmit data. This type of operation could be implemented with the VFC concept in which the wireless UE would attach to one VFC. In general, a VFC would associate with or map to one or multiple unlicensed channels. The wireless UE could then sense the multiple channels in the unlicensed spectrum and select one available channels to transmit through this selected channel (i.e. through the AFC that is associated with this selected channel).

In one of the exemplary embodiments, the disclosure proposes network planning and radio resource allocation for LTE-LAA by using the aforementioned virtual frequency cell concept as follows. Since there could potentially be numerous unlicensed channels as shown in FIG. 1, and network planning in a per channel basis may lead to complications. In order to allocate channels and to conduct network planning with a lower level complexity, a service provider may configure a LTE-LAA unlicensed base station with a VFC which is associated with a set of actual unlicensed channels.

For example, consider the scenario that a first base station has configured one or more VFCs that uses three different carrier frequencies, f1, f2, and f3 as three different channels in an unlicensed spectrum. Similarly, it is assumed that base station 3, base station 5, and base station 7 are also configured to use the same channels, f1, f2, and f3. Also, it is assumed that base station 2, base station 4, and base station 6 are configured to use three different carrier frequencies, f4, f5, and f6 as three different channels in an unlicensed spectrum. In other words, base station 2 could configure a VFC to map to AFC #4 by using a carrier frequency f4 in unlicensed Scell, AFC #5 by using a carrier frequency f5 in unlicensed Scell, and AFC #6 by using a carrier frequency f6 in unlicensed Scell. Under such scenario, a network may plan a configuration to avoid mutual interferences between base station 2 and base station 3 by using different frequency sets. By doing so, even though base station 2 and base station 3 could be closed in proximity, interferences could be avoided as long as different (set of) channels are selected for transmission. For operations related to data communications, base station 1, base station 3, base station 5, and base station 7 may select one channel among candidate set f1, f2, or f3 so that they do not cause significant interferences among each other. As base station 1 selects f2 for data transmission, base station 1 would configure a VFC to be mapped to AFC #2 which is mapped to AFC of carrier frequency 12.

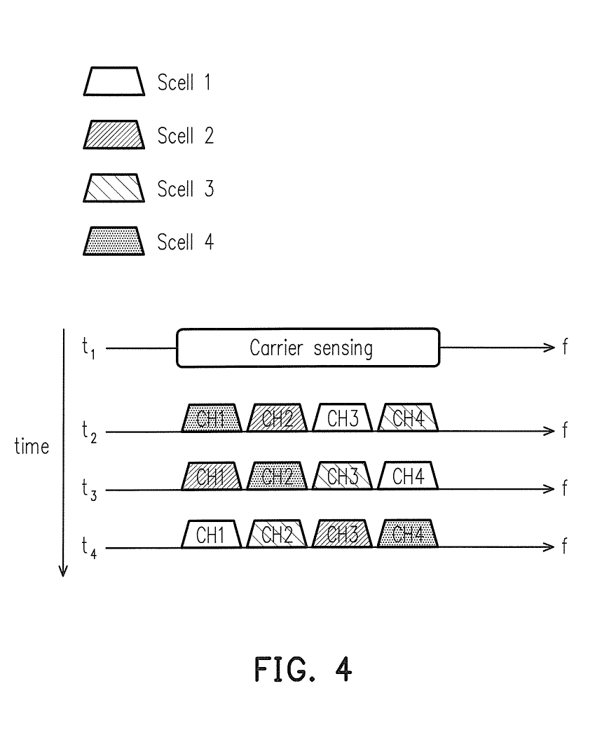

FIG. 4 illustrates an example of channel hopping operation in accordance with one of the exemplary embodiments of the disclosure. In this example, it is assumed that a base station has established a carrier aggregation scheme which contains not limited to a Pcell and at least one Scells operating within an unlicensed spectrum, namely Scell 1, Scell 2, Scell 3, and Scell 4. There is a VFC configured for each of the Scells, and each VFC is mapped to multiple AFCs. The base station in this example could be a LTE eNB and may configure each VFC of the multiple Scells as a channel hopping cell for LTE-LAA operation in the unlicensed frequency spectrum. It is assumed that there are 4 channels, namely channel 1, channel 2, channel 3, and channel 4, within the unlicensed frequency spectrum.

At time t₁, the base station may obtain measurement data with regard to the interference level or may obtain measurement data with regard to whether each of the four channels are available for transmission. The measurement data could be obtained by either directly performing carrier sensing or by receiving measurement reports from UEs for these channels. After obtaining measurement data for these channels, at time t₂, the base station may configure a channel hopping sequence for each of the four Scells. The channel hopping sequence could be transmitted through a control signaling message embedded within a PDCCH via the Pcell. By looking for a specific RNTI upon a blind PDCCH decode, a UE would be able to obtain the channel hopping sequence through the control signaling message.

A Scell could be configured for a channel hopping sequence uniquely for the particular Scell. According to the example of FIG. 4, [3 4 1] sequence is configured for Scell 1. This sequence indicates that the channel hopping VFC of Scell 1 would use channel 3 at time t₂, channel 4 during time t₃, and channel 1 during time t₄. By the same principle, the channel hopping sequence for Scell 2 would be [2, 1, 3], the channel hopping sequence for Scell 3 would be [4, 3, 2], and the channel hopping sequence for Scell 4 would be [1, 2, 4]. This means that at time t₂, t₃, and t₄, a channel would be used by a different Scell.

After t₄, in one of the exemplary embodiments, the same hopping sequence may repeat. This means that, at time t₅, t₆, t₇ (not shown), the hopping sequence would for Scell 1 would be [3 4 1]. Alternatively, the hopping sequence could be one time only, this means that Scell 1 will not execute frequency hopping operation until it has received a new hopping sequence. The Scell that uses the proposed channel hopping sequence would benefit from diversity gain such as by averaging out the interference at different unlicensed channels in different time points.

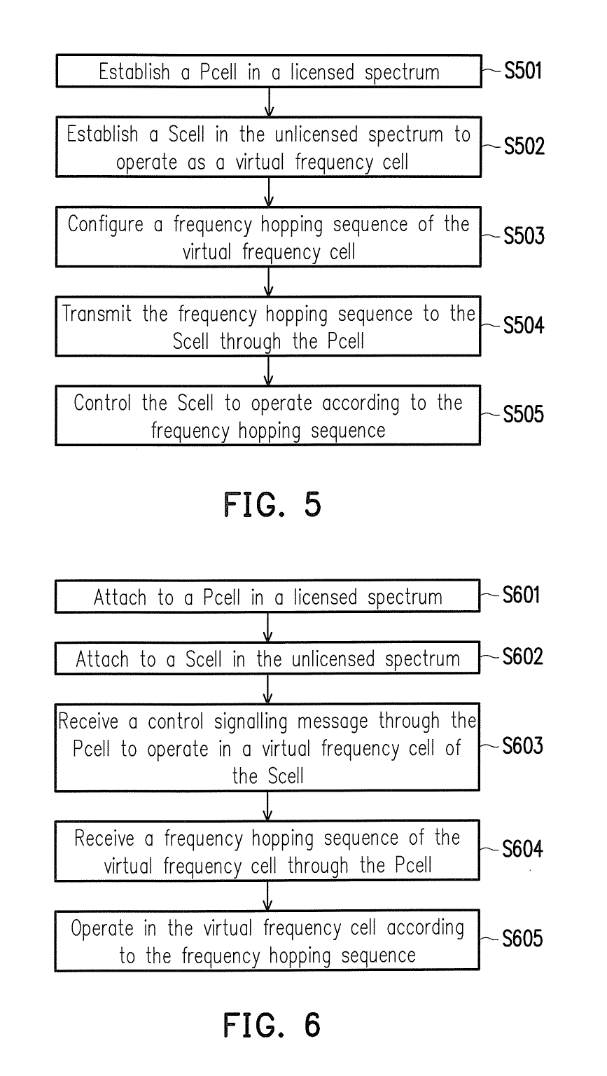

FIG. 5 illustrates a method of wireless communication in an unlicensed spectrum from the perspective of a base station in accordance with one of the exemplary embodiments of the disclosure. In step S501, a base station would establish or operate as a primary serving cell (Pcell) in a licensed spectrum. In step S502, a base station would establish a secondary serving cell (Scell) having a coverage in an unlicensed spectrum, and the secondary serving cell would operate as a virtual frequency cell. In step S503, the base station would configure a frequency hopping sequence for the operation of the virtual frequency cell in which the operating carrier frequency of the virtual frequency cell would change from time to time according to the frequency hopping sequence. In step S504, the base station would transmit the frequency hopping sequence configured in step S503 to the Scell through the Pcell. In step S505, the base station would control the Scell to operate according to the frequency hopping sequence.

In one of the exemplary embodiments, the frequency hopping operation may include: operating under a first carrier frequency in the unlicensed spectrum during a first time period; operating under a second carrier frequency in the unlicensed spectrum during a second time period which is immediately after the first time period; and operating under a third carrier frequency in the unlicensed spectrum during a third time period which is immediately after the second time period.

In one of the exemplary embodiments, the frequency hopping sequence could be preconfigured or dynamically configured based on the current interference levels. The frequency hopping sequence could be configured to be either repetitive or one repetition only.

In one of the exemplary embodiments, the VFC could be mapped to a plurality of actual frequency cells (AFCs). The VFC would have a unique VFC identification (ID), and each actual frequency cell (AFC) would have a unique AFC ID.

In one of the exemplary embodiments, controlling the Scell to operate according to the frequency hopping sequence may involve controlling the Scell to change an operating frequency of the Scell according to the frequency hopping sequence by changing a mapping relationship between the VFC ID and the plurality of AFC IDs. The VFC may stay the same while AFC changes during each frequency hop.

In one of the exemplary embodiments, transmitting the frequency hopping sequence to the Scell may involve transmitting a control signaling message which comprises the frequency hopping sequence to the Scell. The control signaling message could be transmitted through a physical downlink control channel (PDCCH) of the Pcell by using a specific radio network temporary identifier (RNTI).

In one of the exemplary embodiments, configuring a frequency hopping sequence of the VFC may involve performing carrier sensing of a plurality of carrier frequencies of the unlicensed spectrum; and configuring a frequency hopping sequence in response to performing carrier sensing of a plurality of carrier frequencies of the unlicensed spectrum. The base station may configure the frequency hopping sequence by not having its frequency hopping sequence to have overlapped channels with the frequency hopping sequence from a nearby Scell.

In one of the exemplary embodiments, the base station may transmit another control signaling message to activate or deactivate the Scell to operate according to the frequency hopping sequence.

FIG. 6 illustrates a method of wireless communication in an unlicensed spectrum from the perspective of a user equipment (UE) in accordance with one of the exemplary embodiments of the disclosure. In step S601, the UE may attach to a Pcell in a licensed spectrum. In step S602, the UE may attach to a Scell in the unlicensed spectrum. The sequence of step S601 and step S602 could be reversed. In step S603, the UE may receive a control signaling message through the Pcell to operate in a virtual frequency cell of the Scell. In step S604, the UE may receive a frequency hopping sequence of the virtual frequency cell through the Pcell. In step S605, the UE would then operate in the virtual frequency cell according to the frequency hopping sequence.

In one of the exemplary embodiments, the frequency hopping sequence would include operating under a first carrier frequency in the unlicensed spectrum during a first time period; operating under a second carrier frequency in the unlicensed spectrum during a second time period which is immediately after the first time period; and operating under a third carrier frequency in the unlicensed spectrum during a third time period which is immediately after the second time period. The UE may receive a frequency hopping sequence to operate repetitively or may receive an entire sequence at once.

In one of the exemplary embodiments, the VFC would be mapped to a plurality of actual frequency cells (AFCs), the VFC would have a unique VFC identification (ID), and each actual frequency cell (AFC) would have a unique AFC ID.

In one of the exemplary embodiments, operating in the VFC according to the frequency hopping sequence may involve operating in the VFC according to the frequency hopping sequence according to a change of a mapping relationship between the VFC ID and the plurality of AFC IDs. The VFC may stay the same while AFC changes during each frequency hop.

In one of the exemplary embodiments, receiving a frequency hopping sequence of the VFC from the control signaling message may involve receiving the controlling signaling message through a physical downlink control channel (PDCCH) of the Pcell according to a radio network temporary identifier (RNTI).

In one of the exemplary embodiments, the UE may perform a clear channel assessment of a plurality of carrier frequencies of the unlicensed spectrum before an uplink transmission, and the UE would select an available carrier frequency of the unlicensed spectrum for uplink after performing the clear channel assessment of the plurality of carrier frequencies of the unlicensed spectrum.

In one of the exemplary embodiments, the UE may receive another control signaling message to activate or deactivate operating in the VFC according to the frequency hopping sequence.

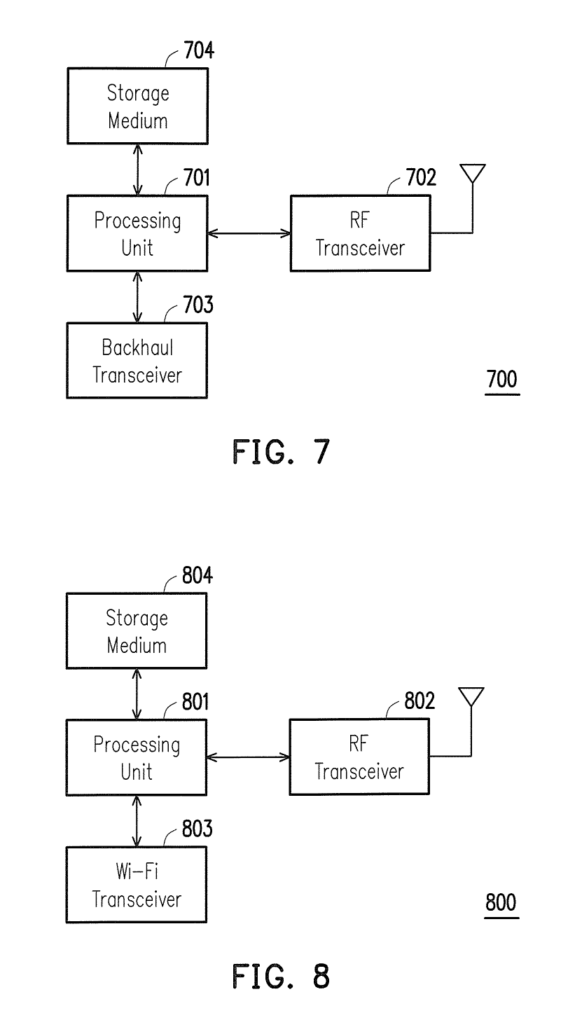

FIG. 7 illustrates a basic functional block diagram of a base station 700 in accordance with one of the exemplary embodiments of the disclosure. The exemplary base station 700 would include not limit to a processing unit 701 electrically coupled to a RF transceiver 702, a backhaul transceiver 703, and a storage medium 704. The RF transceiver 702 contains a transmitter and a receiver tuned to a licensed spectrum. Optionally, the RF transceiver 702 may also contain an additional module to transmit and receive through an unlicensed spectrum. The backhaul transceiver would be for communicating with another base station or for communicating with a small base station operating under the domain of the base station 700. The backhaul transceiver could be used for communicating with a smaller base station operating as a secondary serving cell. The storage medium 704 may store, not limited to, the mapping relationship between the VFC and AFC such as the exact mapping among VFC IDs, AFC IDs and channel numbers as described previously. The storage medium could be a flash drive, a hard disk drive, or any storage drives that may provide temporary or permanent storages.

The processing unit 701 would be configured for executing functions related to the method of wireless communication in an unlicensed spectrum as described in FIG. 5 as well as aforementioned embodiments. The functions of the processing unit 701 could be implemented by using one or more programmable units such as a micro-processor, a micro-controller, a DSP chips, FPGA, etc. The functions of the processing unit 701 may also be implemented with separate electronic devices or ICs, and the functions performed by the processing unit 701 may be implemented within the domain of either hardware or software.

FIG. 8 illustrates a basic functional block diagram of a user equipment 800 in accordance with one of the exemplary embodiments of the disclosure. The exemplary UE 800 would include not limit to a processing unit 801 electrically coupled to a RF transceiver 802, a Wi-Fi transceiver 803, and a storage medium 804. The RF transceiver 802 contains a transmitter and a receiver tuned to a licensed spectrum in order to communicate with a base station or another UE. The UE may contain a hardware transceiver for communication over the unlicensed spectrum, such as a Wi-Fi transceiver 802. The storage medium 704 may store, not limited to, the mapping relationship between the VFC and AFC such as the exact mapping among VFC IDs, AFC IDs and channel numbers as described previously. The storage medium could be a flash drive, a hard disk drive, or any storage drives that may provide temporary or permanent storages.

The processing unit 801 would be configured for executing functions related to the method of wireless communication in an unlicensed spectrum as described in FIG. 6 as well as aforementioned embodiments. The functions of the processing unit 801 could be implemented by using one or more programmable units such as a micro-processor, a micro-controller, a DSP chips, FPGA, etc. The functions of the processing unit 801 may also be implemented with separate electronic devices or ICs, and the functions performed by the processing unit 801 may be implemented within the domain of either hardware or software.

In view of the aforementioned descriptions, the present disclosure is suitable for being used in a wireless communication system and enables a wireless communication network to utilize both licensed spectrum as well as an unlicensed frequency spectrum by implementing frequency hopping virtual frequency cells so as to reduce interferences and increase network efficiency.

No element, act, or instruction used in the detailed description of disclosed embodiments of the present application should be construed as absolutely critical or essential to the present disclosure unless explicitly described as such. Also, as used herein, each of the indefinite articles “a” and “an” could include more than one item. If only one item is intended, the terms “a single” or similar languages would be used. Furthermore, the terms “any of” followed by a listing of a plurality of items and/or a plurality of categories of items, as used herein, are intended to include “any of”, “any combination of”, “any multiple of”, and/or “any combination of multiples of the items and/or the categories of items, individually or in conjunction with other items and/or other categories of items. Further, as used herein, the term “set” is intended to include any number of items, including zero. Further, as used herein, the term “number” is intended to include any number, including zero.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A method of wireless communication in an unlicensed spectrum, applicable to a base station, the method comprising:
establishing a primary serving cell (Pcell) in a licensed spectrum;
establishing a secondary serving cell (Scell) in the unlicensed spectrum to operate as a virtual frequency cell (VFC);
configuring a frequency hopping sequence of the VFC;
transmitting the frequency hopping sequence to the Scell through the Pcell; and
controlling the Scell to operate according to the frequency hopping sequence.

2. The method of claim 1, wherein the frequency hopping sequence comprises:
operating under a first carrier frequency in the unlicensed spectrum during a first time period;
operating under a second carrier frequency in the unlicensed spectrum during a second time period which is immediately after the first time period; and
operating under a third carrier frequency in the unlicensed spectrum during a third time period which is immediately after the second time period.

3. The method of claim 2, wherein the frequency hopping sequence is either repetitive or one repetition only.

4. The method of claim 3, wherein the VFC is mapped to a plurality of actual frequency cells (AFCs), the VFC has a unique VFC identification (ID), and each actual frequency cell (AFC) has a unique AFC ID.

5. The method of claim 4, wherein controlling the Scell to operate according to the frequency hopping sequence comprising:
controlling the Scell to change an operating frequency of the Scell according to the frequency hopping sequence by changing a mapping relationship between the VFC ID and the plurality of AFC IDs.

6. The method of claim 5, wherein the VFC stays the same while AFC changes during each frequency hop.

7. The method of claim 1, wherein transmitting the frequency hopping sequence to the Scell comprising:
transmitting a control signaling message which comprises the frequency hopping sequence to the Scell, wherein the control signaling message is transmitting through a physical downlink control channel (PDCCH) of the Pcell by using a specific radio network temporary identifier (RNTI).

8. The method of claim 1, wherein configuring a frequency hopping sequence of the VFC comprising:
performing carrier sensing of a plurality of carrier frequencies of the unlicensed spectrum; and
configuring a frequency hopping sequence in response to performing carrier sensing of a plurality of carrier frequencies of the unlicensed spectrum.

9. The method of claim 8 further comprising:
configuring frequency hopping sequence to have no overlaps from a nearby Scell.

10. The method of claim 1 further comprising:
transmitting another control signaling message to activate or deactivate the Scell to operate according to the frequency hopping sequence.

11. A method of wireless communication in an unlicensed spectrum, applicable to a user equipment, the method comprising:
attaching to a primary serving cell (Pcell) in a licensed spectrum;
attaching to a secondary serving cell (Scell) in the unlicensed spectrum;
receiving a control signaling message through the primary serving cell (Pcell) to operate in a virtual frequency cell (VFC) of the Scell;
receiving a frequency hopping sequence of the VFC from the control signaling message; and
operating in the VFC according to the frequency hopping sequence.

12. The method of claim 11, wherein the frequency hopping sequence comprises:
operating under a first carrier frequency in the unlicensed spectrum during a first time period;
operating under a second carrier frequency in the unlicensed spectrum during a second time period which is immediately after the first time period; and
operating under a third carrier frequency in the unlicensed spectrum during a third time period which is immediately after the second time period.

13. The method of claim 12, wherein the frequency hopping sequence is either repetitive or one repetition only.

14. The method of claim 13, wherein the VFC is mapped to a plurality of actual frequency cells (AFCs), the VFC has a unique VFC identification (ID), and each actual frequency cell (AFC) has a unique AFC ID.

15. The method of claim 14, wherein operating in the VFC according to the frequency hopping sequence comprising:
operating in the VFC according to the frequency hopping sequence according to a change of a mapping relationship between the VFC ID and the plurality of AFC IDs.

16. The method of claim 15, wherein the VFC stays the same while AFC changes during each frequency hop.

17. The method of claim 11, wherein receiving a frequency hopping sequence of the VFC from the control signaling message comprises:
receiving the controlling signaling message through a physical downlink control channel (PDCCH) of the Pcell according to a radio network temporary identifier (RNTI).

18. The method of claim 11 further comprising:
performing a clear channel assessment of a plurality of carrier frequencies of the unlicensed spectrum; and
selecting an available carrier frequency of the unlicensed spectrum for uplink after performing the clear channel assessment of the plurality of carrier frequencies of the unlicensed spectrum.

19. The method of claim 11 further comprising:
receiving another control signaling message to activate or deactivate operating in the VFC according to the frequency hopping sequence.

20. A user equipment comprising:
a wireless transceiver; and
a processor coupled to the wireless transceiver and is configured at least for:
attaching, through the wireless transceiver, to a primary serving cell (Pcell) in a licensed spectrum;
attaching, through the wireless transceiver, to a secondary serving cell (Scell) in the unlicensed spectrum;
receiving, through the wireless transceiver, a control signaling message through the primary serving cell (Pcell) to operate in a virtual frequency cell (VFC) of the Scell;
receiving, through the wireless transceiver, a frequency hopping sequence of the VFC from the control signaling message; and
operating in the VFC according to the frequency hopping sequence.
